(19) United States
(12) Patent Application Publication
(10) Pub. No.: US 2006/0179137 A1
(43) Pub. Date: Aug. 10, 2006

(54) Method and apparatus for reducing spam on a peer-to-peer network

(76) Inventors: Raymond B. Jennings III, Ossining, NY (US); Jason D. LaVoie, Mahopac, NY (US)

Correspondence Address: MOSER, PATTERSON & SHERIDAN LLP;IBM CORPORATION, 595 SHREWSBURY AVE, SUITE 100, SHREWSBURY, NJ, 07702, US

(21) Appl. No.: 11/051,524

(22) Filed: Feb. 4, 2005

(51) Int. Cl. G06F 15/173

(52) U.S. Cl. 709/224

(57) ABSTRACT

One embodiment of the present method and apparatus for reducing spam on a peer-to-peer network includes determining, in accordance with a list of known spammer nodes, whether a responding node offering data for download is a known spammer node. If the responding node is a known spammer node, communication from the responding node is discarded. However, if the responding node is not a known spammer node, the offered data is retrieved from the responding node. If it is then determined that the retrieved data does, in fact, include spam, at least one other node on the network is notified that the responding node has sent spam. This information then allows the other node to determine whether or not it would like to receive data from the responding node in the future.

### BACKGROUND

The present invention relates generally to computing networks and relates more particularly to the propagation of spam (e.g., unsolicited or spoofed data) over peer-to-peer data transfer networks.

FIG. 1 is a schematic diagram of a network 100 of nodes (e.g., computing devices) interacting in a peer-to-peer (P2P) manner. Generally, a requesting node 101 sends a search message 105 (e.g., containing keywords relating to data that the requesting node 101 wishes to locate) to at least one intermediate node 111 in communication with the requesting node 101 via a peer connection. The intermediate node 111 receives the search message 105 and forwards the search message 105 to at least one additional node 111. Eventually, the search message 105 reaches at least one responding node 103 having the requested data (in some cases, the first intermediate node 111 to which the search message 105 is forwarded will also be a responding node 103). At least one responding node 103 then sends a response message 107 back to the requesting node 101, e.g., via the intermediate nodes 111. The requesting node 101 then requests the relevant data from a responding node 103 by connecting directly to the responding node 103, e.g., via direct connection 109.

In conventional P2P systems, it has become common for some responding nodes 103 to disguise “spam” content (e.g., unsolicited or spoofed data, such as advertisements) inside of transferred files. For example, in response to a search request message 105 including the search terms “Joe's poetry”, a responding node 103 may indicate that is has a file labeled “Joes_poetry.mp3”. However, instead of containing an mp3 file of Joe's poetry, the file in fact contains an advertisement for a product completely unrelated to Joe or poetry. In order to avoid receiving messages from nodes that are known to send spam in this way, a user can filter his or her communications by indicating that messages from specified nodes will not be accepted. However, this filtering must be done manually by the user, and the user's filtering criteria (e.g., relating to information concerning nodes that are known to send spam) cannot be propagated to other users on the P2P network.

Thus, there is a need in the art for a method and apparatus for reducing spam on a P2P network.

### SUMMARY OF THE INVENTION

One embodiment of the present method and apparatus for reducing spam on a peer-to-peer network includes determining, in accordance with a list of known spammer nodes, whether a responding node offering data for download is a known spammer node. If the responding node is a known spammer node, communication from the responding node is discarded. However, if the responding node is not a known spammer node, the offered data is retrieved from the responding node. If it is then determined that the retrieved data does, in fact, include spam, at least one other node on the network is notified that the responding node has sent spam. This information then allows the other node to determine whether or not it would like to receive data from the responding node in the future.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope for the invention may admit to other equally effective embodiments.

FIG. 1 is a schematic diagram of a network of nodes interacting in a peer-to-peer manner;

FIG. 2 is a flow diagram illustrating one embodiment of a method for sharing information concerning known spammers over a P2P network; and

FIG. 3 is a high level block diagram of the spam reduction method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for reducing spam on a P2P network. Embodiments of the present invention enable nodes on a P2P network to share information regarding known spammers (e.g., nodes on the P2P network that have sent spam), for example by propagating spammer notification messages through the P2P network when spam is received from a sender node. These spammer notification messages are used to maintain spammer lists at one or more nodes, so that when a node receives a message over the P2P network, the node can check the source's identity against the spammer list to ensure that the source of the message is not a known spammer.

As used herein, the term “spam” means any unsolicited or spoofed data or communications, including advertisements and communications designed for “phishing” (e.g., designed to elicit personal information by posing as a legitimate institution such as a bank or internet service provider), among other data.

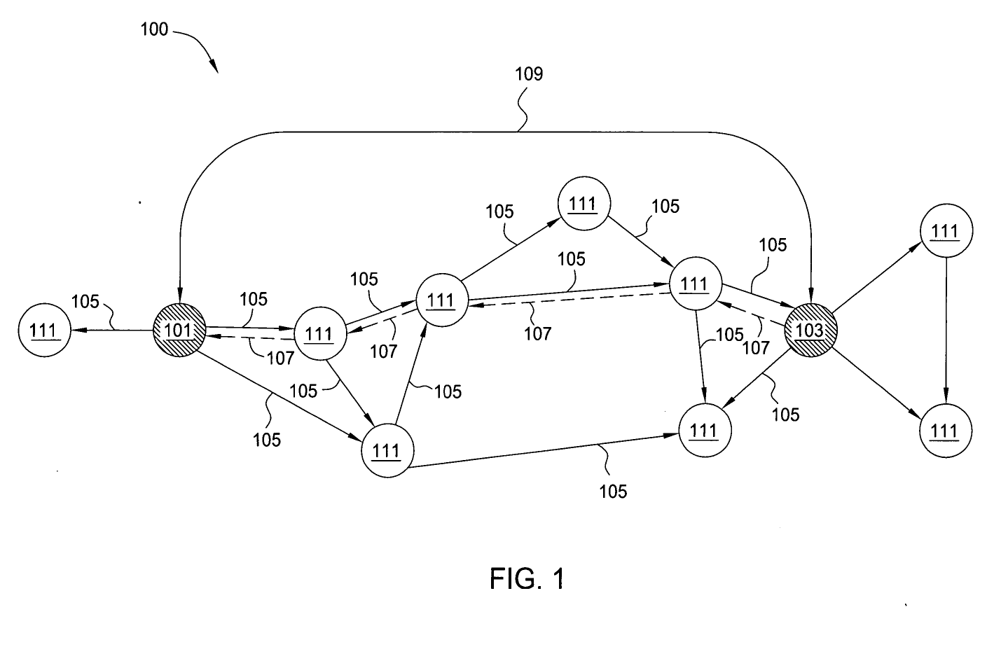

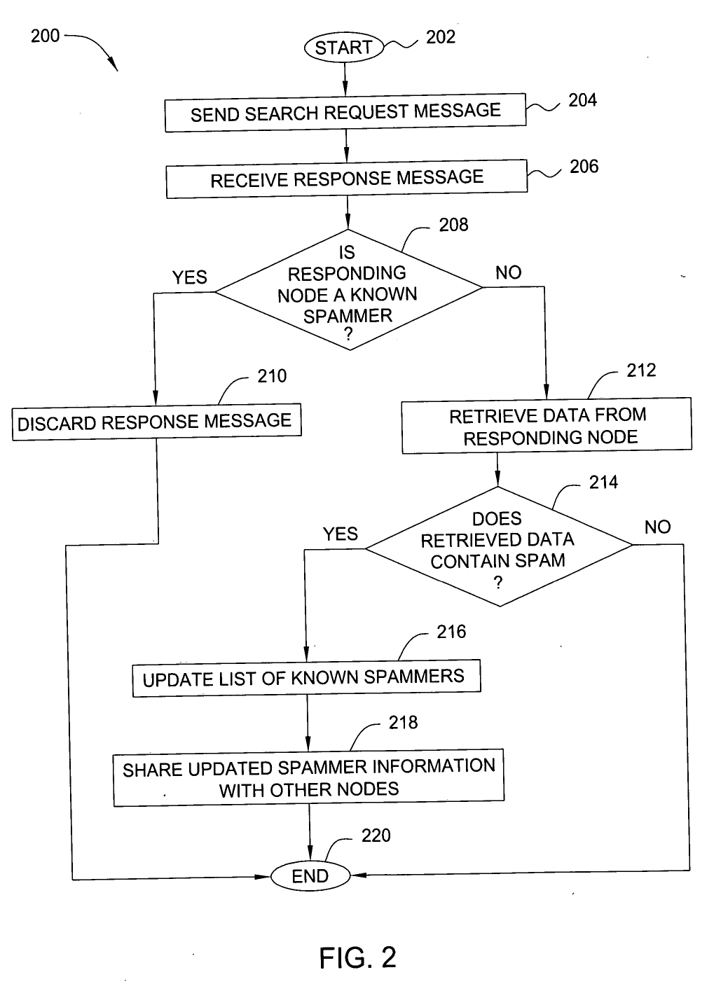

FIG. 2 is a flow diagram illustrating one embodiment of a method 200 for sharing information concerning known spammers over a P2P network. The method 200 may be implemented at, for example, any node on a P2P network such as the network 100 illustrated in FIG. 1.

The method 200 is initialized at step 202 and proceeds to step 204, where the method 200 sends a search request message over the P2P network, e.g., in accordance with the P2P protocols described with reference to FIG. 1. In step 206, the method 200 receives at least one response message in reply to the search request message. That is, the received response message indicates that the responding node has the data requested in the search request message and/or offers this data for download.

In step 208, the method 200 examines the received response message(s) in order to determine if the responding node is a known spammer. In one embodiment, the method 200 maintains a spammer list of nodes that are known to have sent spam in the past. In one embodiment, this spammer list is a local or remote storage mechanism (e.g., database or cache) that comprises at least one entry that includes an identification for a first node that is known to have sent spam (e.g., a hostname and/or an IP address for the first node). In one embodiment, each entry further comprises a count that indicates a number of times within a specific period of time that the method 200 has received a spammer notification message from a second node in the P2P network indicating that the first node has sent spam. Thus, each time a spammer notification message is received that implicates the first node, the first node's count is incremented in the spammer list. Since spammers commonly change their hostnames and/or IP addresses on the P2P network to avoid detection, in one embodiment, the spammer list may be configured so that whole entries or single counts in an entry will expire if not incremented or otherwise modified within a predefined amount of time.

Thus, in one embodiment, the method 200 determines that the responding node is a known spammer if the spammer list includes an entry for the responding node. In another embodiment, the method 200 determines that the responding node is a known spammer if the corresponding count for the responding node meets or exceeds a predefined threshold at which a node is classified as a spammer.

If the method 200 determines in step 208 that the responding node is a known spammer, the method 200 proceeds to step 210 and discards the response message received in step 206. In one embodiment, the method 200 maintains a short cache of discarded response messages that may be used to adjust a node's filter sensitivity. For example, this cache may be used to tune the predefined threshold at which a node is classified as a spammer.

Alternatively, if the method 200 determines in step 208 that the responding node is not a known spammer node (e.g., in accordance with a check of the spammer list), the method 200 proceeds to step 212 and retrieves the data from the responding node that is indicated in the response message. In one embodiment, the data is retrieved in accordance with a manual command from a user. However, those skilled in the art will appreciate that in some cases the user may choose not to retrieve the data even if the responding node is not a known spammer.

The method 200 then determines, in step 214, whether the retrieved data contains spam content. In one embodiment, known spam detection techniques are implemented to examine the contents of the retrieved data. In another embodiment, the method 200 receives a manual response from a user indicating that the retrieved data contains spam content. In yet another embodiment, the method 200 presents the retrieved data to the user along with a metric indicative of a probability that the retrieved data is spam. The retrieved data is then designated as either spam or legitimate (e.g., non-spam) data based on a manual response from the user confirming or denying that the retrieved data is spam. If the method 200 determines that the retrieved data does not contain spam content, the method 200 terminates in step 220.

However, if the method 200 determines in step 214 that the retrieved data does contain spam content, the method 200 proceeds to step 216 and updates the spammer list, e.g., by creating an entry for the responding node and setting the corresponding count to a pre-defined default value (e.g., one). Alternatively, if an entry already existed for the responding node (but the corresponding count fell below the predefined threshold for classifying the responding node as a spammer), the method 200 increments the corresponding count.

The method 200 then proceeds to step 218 and shares the updated spammer information with other nodes in the P2P network. In one embodiment, this information is shared by propagating (e.g., in accordance with known P2P protocols) a notification message through the P2P network that indicates that the method 200 has received spam content from the responding node and identifying the responding node, e.g., by hostname or IP address. In one embodiment, the notification message comprises an entire spammer list including the updated spammer information. In another embodiment, the notification message comprises only the updated spammer information (e.g., as an instruction to increment the responding node's count). In one embodiment, this notification message is a stand-alone message. In another embodiment, the notification message is piggybacked on a response message sent by the node at which the method 200 is executing, or on a message sent between nodes and ultra-nodes, or between ultra-nodes and other ultra-nodes. In the context of the present invention, an ultra-node is a node that acts as a “parent” for one or more “leaf” nodes. That is, an ultra-node knows what data each of its leaf nodes has, and so the ultra-node will typically refrain from forwarding search request messages to leaf nodes that do not have the requested data. In another embodiment, the notification message is sent in a node discovery transaction.

The method 200 then terminates in step 220.

Thus, the present invention enables nodes on a P2P network to reduce the amount of spam received over the P2P network in a substantially automatic manner. By sharing information regarding known spammers, nodes on a P2P network are able to limit an amount of unsolicited data received over the P2P network, with little to no manual user intervention and no assistance from a centralized server.

In one embodiment, nodes on the P2P network may automatically send spammer notification messages (e.g., identifying at least one known spammer on the P2P network and, in some embodiments, a corresponding count for the known spammer) to a new node that has recently joined the P2P network and has not yet had the opportunity to build a spammer list of its own.

Moreover, in one embodiment, the method 200 is further enabled to propagate retraction messages through the P2P network indicating that one or more previously propagated spammer notification messages propagated by the method 200 should be retracted. In one embodiment, these retraction messages will operate to reduce the count of the implicated entry in a receiver's spammer list by one. In one embodiment, if a retraction message serves to reduce the implicated entry's count to zero, the implicated entry is removed from the spammer list.

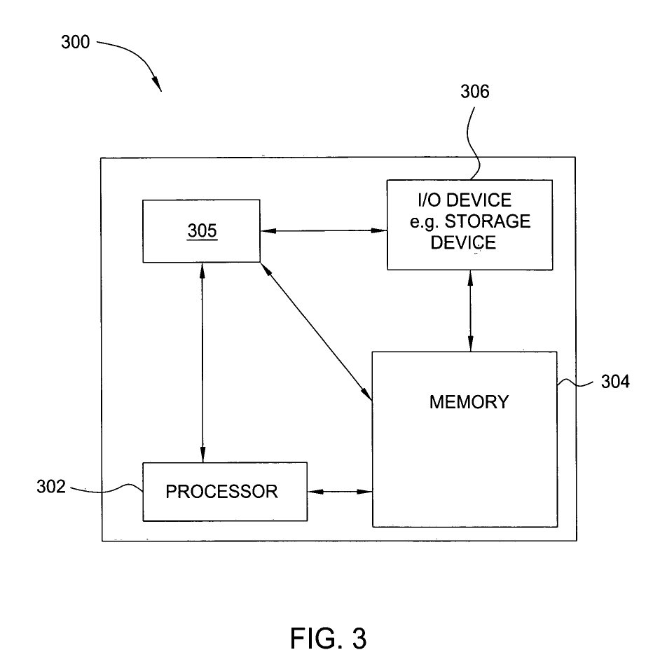

FIG. 3 is a high level block diagram of the spam reduction method that is implemented using a general purpose computing device 300. In one embodiment, a general purpose computing device 300 comprises a processor 302, a memory 304, a spam reduction module 305 and various input/output (I/O) devices 306 such as a display, a keyboard, a mouse, a modem, and the like. In one embodiment, at least one I/O device is a storage device (e.g., a disk drive, an optical disk drive, a floppy disk drive). It should be understood that the spam reduction module 305 can be implemented as a physical device or subsystem that is coupled to a processor through a communication channel.

Alternatively, the spam reduction module 305 can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the spam reduction module 305 for reducing spam received over a P2P network described herein with reference to the preceding Figures can be stored on a computer readable medium or carrier (e.g., RAM, magnetic or optical drive or diskette, and the like).

Thus, the present invention represents a significant advancement in the field of data transfer networks. A method and apparatus are provided that make it possible for nodes on a P2P network to reduce a received amount of unsolicited data by sharing information concerning known spammers with other nodes on the P2P network. Sharing this information makes it possible for spam receptions to be reduced without the need for monitoring by a centralized server or through substantial manual user intervention.

While foregoing is directed to the preferred embodiment of the present invention, other and further embodiments of the invention may be devised without departing from the basic scope thereof, and the scope thereof is determined by the claims that follow.

1. A method for limiting spam received by a first node in a network, said method comprising:
determining, in accordance with a list of spammer nodes, whether a second node offering data for download is a spammer node;
retrieving said offered data if said second node is not a spammer node; and
notifying at least one third node that said second node is a spammer node if said retrieved data comprises spam content.

2. The method of claim 1, further comprising:
discarding a communication offering said data if said second node is a spammer node according to said list of spammer nodes.

3. The method of claim 1, wherein said list of spammer nodes comprises at least one entry for at least one spammer node that is known to have previously sent spam over said network.

4. The method of claim 3, wherein said determining comprises:
identifying said second node in accordance with a communication offering said data; and
determining whether said list of spammer nodes includes an entry for said second node.

5. The method of claim 4, wherein said second node is determined to be a spammer node if said list of spammer nodes includes an entry for said second node.

6. The method of claim 3, wherein said at least one entry comprises:
an identification for said at least one spammer node; and
a count indicating a number of times that said at least one spammer node is known to have sent spam over said network.

7. The method of claim 6, wherein said at least one entry expires if said count is not modified within a predefined amount of time.

8. The method of claim 6, wherein said second node is determined to be a spammer node if a count corresponding to an entry for said second node meets or exceeds a predefined threshold.

9. The method of claim 1, wherein said retrieving comprises:
downloading said offered data from said second node; and
examining said downloaded data for spam content.

10. The method of claim 9, further comprising:
updating an entry for said second node in said list of spammer nodes if said downloaded data contains spam content.

11. The method of claim 10, wherein said updating comprises:
creating a new entry in said list of spammer nodes for said second node, said new entry comprising:
an identification for said second node; and
a count indicating that said second node has sent spam at least once over said network.

12. The method of claim 10, wherein said updating comprises:
incrementing a count in said entry for said second node, said count indicating a number of times that said second node is known to have sent spam over said network.

13. The method of claim 1, wherein said notifying comprises:
propagating a spammer notification message through said network, said spammer notification message notifying said at least one third node that said second node has sent spam to said first node.

14. The method of claim 13, wherein said spammer notification message is implemented by said at least one third node to update said at least one third node's list of spammer nodes.

15. The method of claim 14, wherein said at least one third node's list of spammer nodes is updated by:
locating an entry for said second node, said entry comprising an identification for said second node and a count indicating a number of times that said second node is known to have sent spam over said network; and
incrementing said count to reflect receipt of said spammer notification message.

16. The method of claim 1, further comprising:
retracting said notification if said second node is later determined to not be a spammer node.

17. The method of claim 16, wherein said retraction is operable to modify a list of spammer nodes for said at least one third node.

18. The method of claim 17, wherein said modification comprises:
locating an entry in said at least one third node's list of spammers for said second node, said entry comprising an identification for said second node and a count indicating a number of times that said second node is known to have sent spam over said network; and
decrementing said count to reflect receipt of said spammer notification message.

19. A computer readable medium containing an executable program for limiting spam received by a first node in a network, where the program performs the steps of:
determining, in accordance with a list of spammer nodes, whether a second node offering data for download is a spammer node;
retrieving said offered data if said second node is not a spammer node; and
notifying at least one third node that said second node is a spammer node if said retrieved data comprises spam content.

20. Apparatus for limiting spam received by a first node in a network comprising:
means for determining, in accordance with a list of spammer nodes, whether a second node offering data for download is a spammer node;
means for retrieving said offered data if said second node is not a spammer node; and
means for notifying at least one third node that said second node is a spammer node if said retrieved data includes spam content.
